(19) United States
(12) Patent Application Publication
(10) Pub. No.: US 2002/0054095 A1
(43) Pub. Date: May 9, 2002

(54) USER-ADAPTIVE VARIABLE-ENVIRONMENT SYSTEM

(76) Inventors: HAJIME ASAMA, WAKO-SHI (JP); HAYATO KAETSU, TSURUGASHIMA-SHI (JP); ISAO ENDO, KOKUBUNJI-SHI (JP); YOSHINOBU SHIMOJYO, HACHIOJI-SHI (JP); ISAO SAKAGUCHI, TACHIKAWA-SHI (JP)

Correspondence Address: JACOBSON PRICE HOLMAN & STERN, 400 SEVENTH STREET N W, WASHINGTON, DC, 20004

(21) Appl. No.: 09/080,461

(22) Filed: May 19, 1998

(30) Foreign Application Priority Data
Nov. 11, 1997 (JP) 308809/1997

(51) Int. Cl. G06F 3/00

(52) U.S. Cl. 345/762

(57) ABSTRACT

A user-adaptive variable-environment system comprises a computer provided with a user recognizing unit, and an information storage remedium which to be applied to the user recognizing unit. The information storage medium stores user-environment information about environments suitable for users, and the user recognizing unit reads the user-environment information stored in the information storage medium and changes operating environments of the computer automatically so as to fit with the user-environment information.

### BACKGROUND OF THE INVENTION

1. Field of the Invention

The present invention relates to a machine system, such as a computer system to be used by a plurality of unspecified persons, and, more particularly, to a user-adaptive variable-environment system capable of changing its operating environments or its set environments according to user information.

2. Description of the Related Art

The modern society has undergone a rapid change with the progress of computer technology and is still making a progressive advancement. Computers serve as important elements of infrastructures of the society and personal computers are being progressively diffused in the general public. The speed of diffusion of personal computers in the general public has been further enhanced by the development of network computing.

The computers are controlled by instructions described by particular machine languages. Different computer manufacturers and different types of computers use different machine languages, respectively. Therefore, to execute some procedures by a computer, the contents of the procedures must be described by a machine language specific to the computer.

Under such circumstances, operating systems (OSs) have been developed. An OS translates an OS language into a machine language available to a computer in which the OS is installed to standardize the description of the contents of procedures. Currently used principal OSs are UNIX, MS-DOS provided by Microsoft Inc., OS2 provided by IBM Corp., and MAC-OS provided by Apple Computer Inc. These OSs are used in combination with window software to realize further enhanced functions. For example, MS-DOS is used in combination with MS-Windows, and UNIX in combination with the x-windows.

Although OS providers tried to propose a new standard OS (Java system), the new standard OS has not been put into practice from the view point of business management to maintain the originality of the OS providers. Therefore, a plurality of OSs are used in the current computer environment. The computer environments, as well as OSs, include many elements which have not yet been standardized. For example, keyboard layout has not been perfectly standardized. It may safely be said that there is no possibility of the standardization of methods of using pieces of application software, such as pieces of software for word processors and communication software, at all.

The recent development of network computing has made the conventional functions of computers as processing units undergo a great change, and increased the importance of computers as terminal units. More specifically, in an established system of using computers, a computer at hand is not used as a processing unit but is used as a terminal unit for operating other computer connected thereto, arithmetic operations are carried out substantially by the other computer, and only the results of arithmetic operations are displayed by a display connected to the computer at hand.

Under the foregoing existing circumstances, the general user learns an OS language (or window software) and various pieces of application software selected for himself or herself, carries out various processes by operating a personal computer including a keyboard and such, and loaded with the OS and the pieces of application software, and, sometimes, connects the personal computer to a network to use the personal computer as a terminal unit.

For example, in a computer system as shown in FIG. 5, in which a first personal computer A, which is manageable for a user, and a second personal computer B, which is not manageable for the user, are connected to a network C, the user of the personal computer B is able to operate the personal computer A through the network C. In this computer system, the personal computer B is able to use data stored in the personal computer A or application software loaded into the personal computer A for various processes.

Some machines other than computers are capable of changing their set environments according to their purposes. For example, some elevators installed in buildings is provided with a special switch for use by a person on a wheelchair. If the special switch is operated, the set environment of the elevator is changed to establish set environment convenient for a person on a wheel chair; that is, for example, duration for opening the door of the elevator is extended or the moving speed of the cage of the elevator is reduced.

In the computer system shown in FIG. 5, the operating environments of the second personal computer B as turned on is usually not the same as that of the first personal computer A because the second personal computer B is not manageable for the user. For example, the OS installed in the second personal computer B is different from that installed in the first computer A, The keyboard assignment of the second computer B is different from that of the first computer A or, in some cases, the language used by the second computer B for displaying information is different from that used by the first computer A.

In case of the operating environments of the second personal computer B is different from those of the first personal computer A, if the user builds the same operating environments as those of the first personal computer A in the second personal computer B or fetches those from the first personal computer A in the second personal computer B, the user must operate the second personal computer in its operating environments. If the user does not know the method of operating the second personal computer B in its operating environments at the start, the user cannot operate the first personal computer A which is physically usable through the network C.

D. Eng. H. A., one of the inventors of the present invention, had the following experience. While attending an international conference in France, D. Eng. H. A. tried to read mails delivered to his mail address in Japan through the Internet by operating a computer installed in the place for the conference. However, all the display of the computer were expressed in French, and the communication software for using the Internet was different from that he used to use. He had sat operating the computer for three hours when he finished reading mails for him at last by repeating operations by a trial-and-error method.

Recent machines, such as elevators, are provided with special switches for changing the set environments. However, the special switches require additional costs and work. The special switch may possibly be accidentally operated. If the special switch is operated accidentally, the set environments inconvenient to normal persons can be set for an adverse effect.

### SUMMARY OF THE INVENTION

The present invention has been made in view of the foregoing problems and it is therefore an object of the present invention to provide a user-adaptive variable-environment system capable of automatically changing its operating environments or its set environments according to user's option.

According to a first aspect of the present invention, a user-adaptive variable-environment system comprises a computer provided with an operating environment and a user recognizing unit, and an information storage medium to be applied to the user recognizing unit. The information storage medium stores user-environment information about environment suitable for a user, the user recognizing unit reads the user-environment information stored in the information storage medium, and changes the operating environment of the computer so as to fit with the user environment information.

Since the operating environment suitable for the user can be automatically set by the computer on the basis of the user environment information, the user is able to save time and labor necessary for setting the operating environment suitable for the user, so that the computer open to the general public is used actively by unspecific persons and the user-adaptive variable-environment system has an inestimably great effect in improving the efficiency of human activities if the user-adaptive variable-environment system of the present invention is applied to worldwide applications.

According to a second aspect of the present invention, a user-adaptive variable-environment system comprises a data server storing user-environment information corresponding to user-ID information identifying users, a computer provided with an operating environment and a user recognizing unit and connected to the data server, and an information storage medium to be applied to the user recognizing unit. The information storage medium stores user-ID information, and the user recognizing unit reads the user-ID information stored in the information storage medium, fetches the user-environment information corresponding to the user-ID information from the data server and changes the operating environment of the computer so as to fit with the user-environment information.

Since the information storage medium stores only the user-ID information, faults caused in stored information by carrying the information storage medium can be easily dealt with. Since the user environment information is read from the data server, the performance of the user-adaptive variable-environment system is not very greatly dependent on the performance of the user recognizing unit or that of the computer. The user environment information can be easily changed and stored.

According to a third aspect of the present invention, a user adaptive variable-environment system comprises a data server storing user setting information corresponding to user information, and a machine provided with a set environment and a user recognizing unit and connected to the data server. The user recognizing unit recognizes voice information, image information or code information provided by a user and identifies the corresponding user information, fetches the user setting information corresponding to the user information from the data server, and changes the set environment of the machine so as to fit with the user setting information.

The machine provides set operating environment suitable for the user automatically on the basis of the user setting information and therefore the user-adaptive variable-environment system need not be provided with special switches or the like for different users and is capable of providing different services for different users. Therefore, the user is able to use the user-adaptive variable-environment system without operating any special switch.

### BRIEF DESCRIPTION OF THE DRAWINGS

The above and other objects, features and advantages of the present invention will become more apparent from the following description taken in connection with the accompanying drawings, in which:

FIG. 1 is block diagram of a user-adaptive variable-environment system in a first embodiment according to the present invention;

FIG. 2 is block diagram of a user-adaptive variable-environment system in a second embodiment according to the present invention;

FIG. 3 is block diagram of a user-adaptive variable-environment system in a third embodiment according to the present invention;

FIG. 4 is block diagram of a user-adaptive variable-environment system in a fourth embodiment according to the present invention; and

FIG. 5 is an illustration of a conventional computer system including two personal computers interconnected through a network.

### DESCRIPTION OF THE PREFERRED EMBODIMENTS

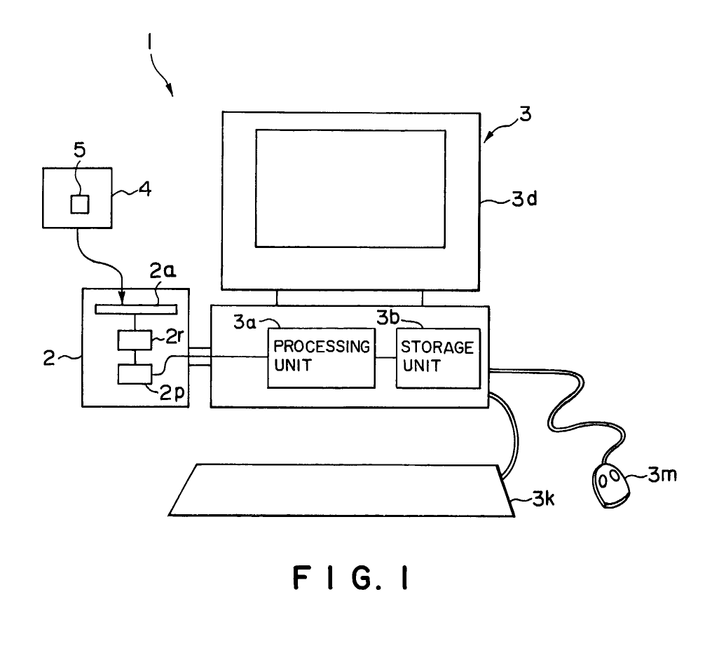

FIG. 1 shows a user-adaptive variable-environment system 1 in a first embodiment according to the present invention. Referring to FIG. 1, the user-adaptive variable-environment system 1 comprises a computer 3 provided with a user recognizing unit 2, and an information storage medium 4 to be applied to the user recognizing unit 2. The information storage medium 4 stores user-environment information 5 about environments suitable for a user. The user recognizing unit 2 reads the user-environment information 5 stored in the information storage medium and changes the operating environments of the computer 3 according to the user-environment information 5.

The user-environment information 5 stored in the information storage medium 4 is information about environments selected by the user including an OS, application software, a keyboard layout, a display language and such. The information storage medium 4 employed in this embodiment stores all the pieces of information necessary for changing the operating environments of the computer 3 on the basis of the user-environment information 5.

The user recognizing unit 2 is suitable for the information storage medium 4. The user recognizing unit 2 has a slot 2a through which the information storage medium 4 is loaded into the user recognizing unit 2, a reader 2r for reading information stored in the information storage medium 4, a controller 2p capable of changing the operating environments of the computer 3 on the basis of the information read from the information storage medium 4. The computer 3 comprises an processing unit 3a, a storage unit 3b, a display 3d, a keyboard 3k and a mouse 3m. The controller 2p controls the processing unit 3a and the storage unit 3b of the computer 3 to change the operating environments of the computer 3, such as the layout of the keys of the keyboard 3k, a method of using the mouse 3m, a language in which information is displayed on the display 3d, and set application software.

The information storage medium 4 may be any portable information storage medium, such as a FD, a MD or a PD, and the user recognizing unit 2 may be any device that is capable of dealing with information stored in the information storage medium 4. An ID card is a particularly preferable information storage medium 4. If the information storage medium 4 is an ID card, the information storage medium 4 need not be inserted through the slot 2a into the user recognizing unit 2 and the user may keep the information storage medium 4 in the breast pocket.

In operation, the user who intends to execute various processes by operating the computer 3 needs to enter instructions by operating the keyboard 3k or the mouse 3m of the computer 3. If the layout of the keys of the keyboard 3k, the assignment of the keys of the keyboard 3k to input codes, the method of operating the mouse 3m and the language in which the display 3d displays information can be understood by the user, and the user is able to carry out operations by using the operating environments of the computer 3 as it is, the user-adaptive variable-environment system need not be used. If the user is unable to use the operating environments of the computer 3 to carry out operations or if the user is able to use the operating environments of the computer 3 but desires to use other operating environments more suitable for the user, the user-adaptive variable-environment system of the present invention is used. When the user desires to use the user-adaptive variable-environment system of the present invention, the user prepares the information storage medium 4 storing the user-environment information 5. Information is stored in the information storage medium 4 by any method fitting with both the user recognizing unit 2 and the computer 3 so that the reader 2r of the user recognizing unit 2 is able to read the information quickly and the controller 2p is able to change the operating environments of the computer 3 quickly.

The user who intends to use the computer 3 inserts the prepared information storage medium 4 through the slot 2a into the user recognizing unit 2. Subsequently, the reader 2r of the user recognizing unit 2 reads the user-environment information 5 from the information storage medium 4 and transfers it to the controller 2p. Then, the controller 2p changes the operating environments of the computer 3 on the basis of the user-environment information 5 by controlling the processing unit 3a and the storage unit 3b of the computer 3. Thus, the computer 3 is set up with operating environments, i.e., the layout of the keys of the keyboard 3k, the assignment of the keys of the keyboard 3k to input codes, the method of operating the mouse 3m, and the language in which information is displayed on the display 3d, corresponding to the user-environment information 5, so that the user is able to operate the computer 3.

As mentioned above, the computer 3 provides operating environments suitable for the user automatically on the basis of the user-environment information 5. Therefore, the user is able to save time and labor necessary for setting the operating environments, so that the efficiency of work using the computer 3 is improved remarkably. Even if the computer 3 provides operating environments which cannot be used by the user, the user can work by using the computer 3 by changing the operating environments of the computer 3 by the user-adaptive variable-environment system in the first embodiment of the present invention. More specifically, the user-adaptive variable-environment system of the present invention enables the user to operate the computer 3 by operating environments selected by the user, such as the OS, the language in which information is displayed on the display 3d, the application software, the layout of keys of the keyboard 3k, the assignment of the keys of the keyboard 3k to input codes and the method of operating the mouse 3m.

The computer 3 of the user-adaptive variable-environment system in this embodiment is effective in securing data security. For example, the operating environments serve as a password, that is, the operating environments are constructed by the user so that access to data stored in the computer 3 cannot be achieved unless the computer 3 is set up with the operating environments selected by the user. If the operating environments serve as a password, the user is exempted from a trouble to remember a special password, and there is no possibility that the secrecy of the password is revealed. Even if other persons other than the user try to access the data, the other persons are unable to access the data unless the other persons know both the method of setting operating environments and the method of operating the computer 3 in the operating environments set specially by the user. Therefore, the computer 3 is highly effective in maintaining data security.

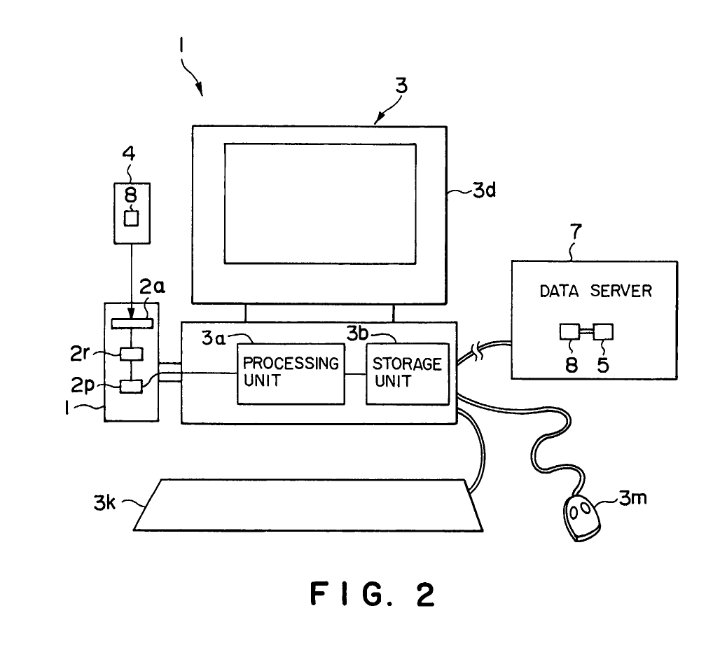

FIG. 2 shows a user-adaptive variable-environment system 1 in a second embodiment according to the present invention. Referring to FIG. 2, the user-adaptive variable-environment system 1 has a computer 3 connected to a data server 7, and an information storage medium 4 storing user-ID information 8 instead of the user-environment information 5. The user-adaptive variable-environment system in the second embodiment substantially the same in other respects as the user-adaptive variable-environment system in the first embodiment shown in FIG. 1. Therefore, parts of the user-adaptive variable-environment system in the second embodiment like or corresponding to those of the user-adaptive variable-environment system in the first embodiment shown in FIG. 1 are designated by the same reference characters and the description thereof will be omitted.

The information storage medium 4 included in the user-adaptive variable-environment system in the second embodiment stores only the user-ID information 8, and the data server 7 stores the user-environment information 5 corresponding to the user-ID information 8. The user recognizing unit 2 included in the second embodiment comprises a reader 2r for reading the user-ID information 8 stored in the information storage medium 4, and a controller 2p capable of controlling the processing unit 3a and the storage unit 3b of the computer 3 so as to fetch (down load) the user-environment information 5 corresponding to the user-ID information 8 from the data server 7 to change the operating environments of the computer 3 on the basis of the user-environment information 5.

In operation, the user stores information about operating environments suitable for the user, namely, the user-environment information 5, beforehand in the data server 7 in correspondence with the user-ID information 8. The user-ID information 8 is stored in the information storage medium 4. Information is stored in the data server 7 and information is stored in the information storage medium 4 respectively by any method fitting with both the user recognizing unit 2 and the computer 3 so that the reader 2r of the user recognizing unit 2 is able to read the information quickly and the controller 2p is able to change the operating environments of the computer 3 quickly.

The user who intends to use the computer 3 inserts the prepared information storage medium 4 through the slot 2a into the user recognizing unit 2. Subsequently, the reader 2r of the user recognizing unit 2 reads the user-ID information 8 from the information storage medium 4 and transfers it to the controller 2p. Then, the controller 2p controls the processing unit 3a and the storage unit 3b of the computer 3 on the basis of the user-ID information 8 to retrieve the user-environment information 5 from the data server 7, and changes the operating environments of the computer 3 on the basis of the user-environment information 5. Only the front end of the computer 3 may be changed. Consequently, the user is able to use the computer 3 set up with the user's operating environments.

Since only the user-ID information 8 needs to be stored in the information storage medium 4, faults caused in stored information by carrying the information storage medium 4 employed in the second embodiment can be more easily dealt with than those caused in the information stored in the information stored medium 4 employed in the first embodiment. Since the user-environment information 5 is read from the data server 7, the performance of the user-adaptive variable-environment system is not very greatly dependent on the performance of the user recognizing unit 2 or that of the computer 3 if a communication system capable of enhanced performance is used. The user environment information 5 can be easily changed and stored.

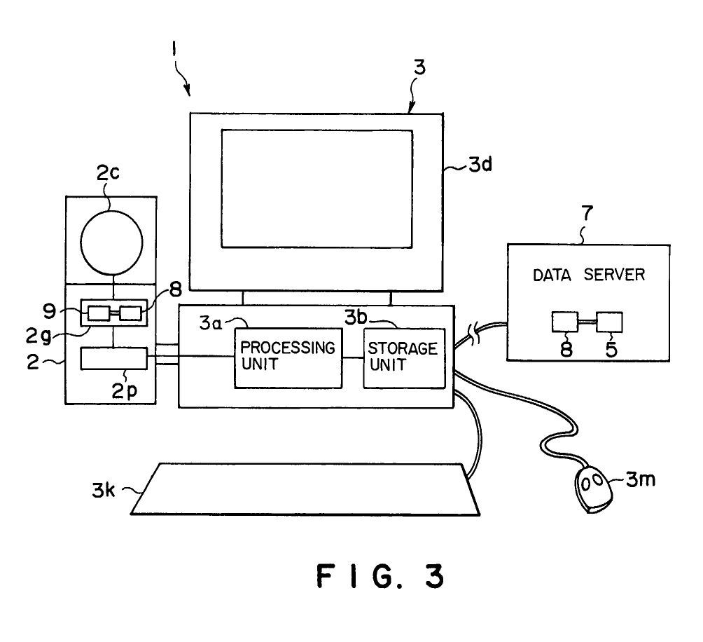

FIG. 3 shows a user-adaptive variable-environment system 1 in a third embodiment according to the present invention. Referring to FIG. 3, the user-adaptive variable-environment system 1 is not provided with any component corresponding to the information storage medium 4, and has user recognizing unit 2 having a CCD camera 2c, an image processing unit 2g and a controller 2b. The user-adaptive variable-environment system in the third embodiment is substantially the same in other respects as the user-adaptive variable-environment system in the second embodiment shown in FIG. 2. Parts of the user-adaptive variable-environment system in the third embodiment like or corresponding to those of the second embodiment shown in FIG. 2 are designated by the same reference characters and the description thereof will be omitted.

Referring to FIG. 3, the user recognizing unit 2 has the CCD camera 2c capable of taking an image about the user, the image processing unit 2g capable of processing image information 9 about the user provided by the CCD camera 2c to identify the user and specify user-ID information 8, and the controller 2b capable of retrieving user environment information 5 corresponding to the specified user-ID information 8 from the data server 7 to change the operating environments of the computer 3 on the basis of the user-environment information 5.

The operation of the user-adaptive variable-environment system 1 will be described hereinafter. The user sets the image processing unit 2g beforehand so as to be able to specify the user-ID information 8 from image information 9 about the user, and stores user-environment information 5 in the data server 7 in correspondence with the user-ID information 8. Information is stored in the data server 7 by any method which enables the controller 2b to achieve changing the operating environments of the computer 3 quickly.

When the user desires to use the computer 3, the user locates himself in front of the CCD camera 2c to enable the CCD camera 2c to take the user's image. The CCD camera 2c takes the user's image and gives user image information 9 to the image processing unit 2g. Then, the image processing unit 2g specifies user-ID information 8 on the basis of the user image information 9. Subsequently, the controller 2p controls the computer 3 to retrieve user-environment information 5 corresponding to the specified user-ID information 8 from the data server 7 and changes the operating environments of the computer 3 on the basis of the user-environment information 5. Consequently, the user is able to use the computer 3 set up with operating environments suitable for the user. Since the user-ID information 8 is specified on the basis of the image information 9, the user need not carry any information storage medium 4 with him or her.

The CCD camera 2c may be replaced with any suitable image reader other than the CCD camera 2c such as a fingerprint reader or a retinal pattern reader. The user-adaptive variable-environment system in the third embodiment may specify the user-ID information 8 on the basis of voice information or code information. If voice information is used for specifying the user-ID information 8, the user-adaptive variable-environment system needs a microphone and a voice identifying device. If code information is used for specifying the user-ID information 8, the user-adaptive variable-environment system needs a code input device and a code analyzer. In either case, data showing the correspondence between user ID information 8 and the corresponding voice or codes must be stored beforehand in the voice identifying device or the code analyzer.

The user-adaptive variable-environment system may be provided with a charging system to charge the user for an operation for fetching an OS or other application software from the data server 7. Such a charging system can be one of new application software providing methods.

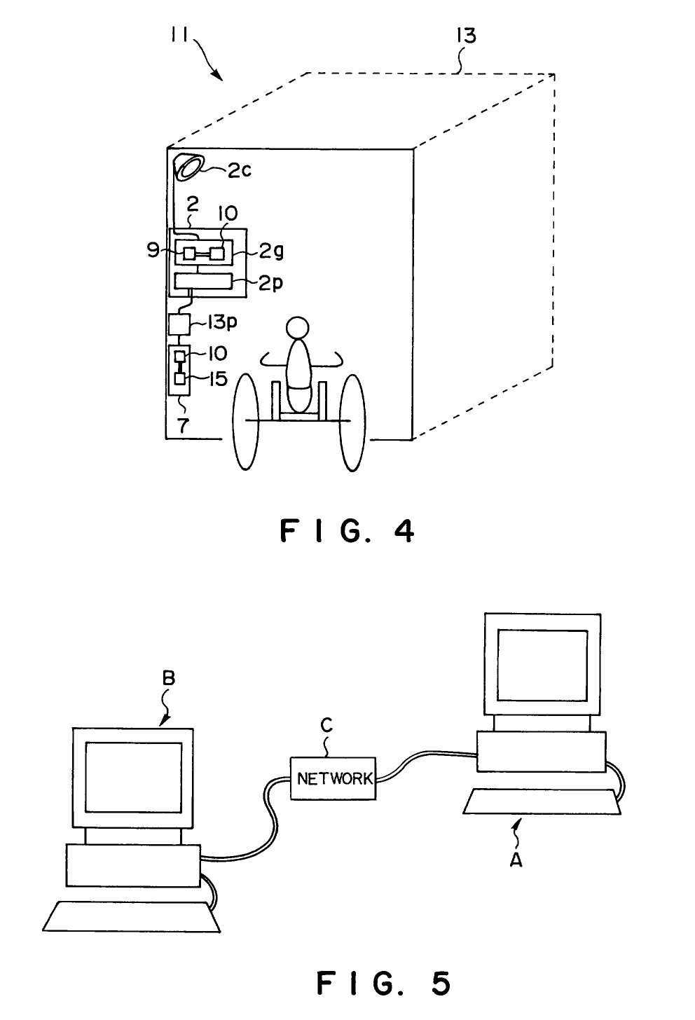

FIG. 4 shows a user-adaptive variable-environment system 11 in a fourth embodiment according to the present invention. Referring to FIG. 4, the user-adaptive variable-environment system 11 is provided with an elevator 13 as a machine whose set environments can be changed fitting with the user instead of the computer 3 of the foregoing embodiments, user setting information 15 is used instead of the user-environment information 5, and user information 10 is used for specifying the user setting information 15 instead of the user-ID information 8. The user-adaptive variable-environment system 11 in the fourth embodiment is substantially the same in other respects as the third embodiment shown in FIG. 3. In FIG. 4, parts like or corresponding to those shown in FIG. 3 are designated by the same reference characters and the description thereof will be omitted. The user-adaptive variable-environment system 11 has a data server 7 for storing the user setting information 15 corresponding to the user information 10, a user recognizing unit 2 comprising a CCD camera 2c, an image processing unit 2g and a controller 2p, and an elevator controller 13p connected to the controller 2p and the data server 7.

The CCD camera 2c takes an image about the user and gives image information 9 to the image processing unit 2g. The image processing unit 2g finds the user information 10 representing the condition of the user on the basis of the user image information 9. The controller 2p controls the elevator controller 13p, fetches the user setting information 15 corresponding to the user information 10 from the data server 7, and changes the set environments of the elevator 13 on the basis of the user setting information 15. Consequently, the user is able to use the elevator 13 in the set environments suitable for the user.

Since the set environments of the elevator 13 are changed automatically so that the set environments of the elevator 13 fit with the user setting information 15, elevator 13 need not be provided with any special switch or the like, and the user-adaptive variable-environment system 11 is capable of providing services suitable for individual users. The user-adaptive variable-environment system 11 can be designed so as to permit only authorized users to use a mechanical apparatus. For example, it is possible to allow only authorized persons to go to specific floors by the elevator.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

What is claimed is:

1. A user-adaptive variable-environment system comprising:
a computer provided with an operating environment and a user recognizing unit; and
an information storage medium to be applied to the user recognizing unit;
wherein the information storage medium stores user environment information about environment suitable for a user, and the user recognizing unit reads the user-environment information stored in the information storage medium and changes the operating environment of the computer so as to fit with the user-environment information.

2. The user-adaptive variable-environment system according to claim 1, wherein the information storage medium is portable.

3. The user-adaptive variable-environment system according to claim 1, wherein the information storage medium is an ID card.

4. The user-adaptive variable-environment system according to claim 1, wherein the user-environment information includes at least one of a type of an OS, a language in which information is to be displayed, usable application software and a key layout.

5. The user-adaptive variable-environment system according to claim 1, wherein the user-environment information serves as a password.

6. A user-adaptive variable-environment system comprising:
a data server storing user-environment information corresponding to user-ID information identifying users;
a computer provided with an operating environment and a user recognizing unit and connected to the data server; and
an information storge medium to be applied to the user recognizing unit;
wherein the information storage medium stores user-ID information, and the user recognizing unit reads the user-ID information stored in the information storage medium, fetches the user-environment information corresponding to the user-ID information from the data server and changes the operating environment of the computer so as to fit with the user-environment information.

7. The user-adaptive variable-environment system according to claim 1, wherein
the information storage medium is portable.

8. The user-adaptive variable-environment system according to claim 6, wherein
the information storage medium is an ID card.

9. The user-adaptive variable-environment system according to claim 6, wherein
the user-environment information includes at least one of a type of an OS, a language in which information is to be displayed, usable application software and a key layout.

10. The user-adaptive variable-environment system according to claim 6, wherein
the user-environment information serves as a password.

11. A user-adaptive variable-environment system comprising:
a data server storing user setting information corres ponding to user information, and
a machine provided with a set environment and a user recognizing unit and connected to the data server;
wherein the user recognizing unit recognizes information provided by a user, identifies the user information corresponding to the information provided by the user, fetches the user setting information corresponding to the user information from the data server, and changes the set environment of the machine so as to fit with the user setting information.

12. The user-adaptive variable-environment system according to claim 11, wherein
the user recognizing unit recognizes image information provided by the user.

13. The user-adaptive variable-environment system according to claim 12, wherein
the user recognizing unit has a CCD camera and an image processing unit.

14. The user-adaptive variable-environment system according to claim 11, wherein
the user recognizing unit recognizes voice information provided by the user.

15. The user-adaptive variable-environment system according to claim 11, wherein
the user recognizing unit recognizes code information provided by the user.

16. The user-adaptive variable-environment system according to claim 11, wherein
the machine is a computer, the user information is user-ID information identifying the user; and the user setting information is user-environment information.

17. The user-adaptive variable-environment system according to claim 11, wherein
the machine is an elevator.

18. The user-adaptive variable-environment system according to claim 17, wherein
the user information includes information indicating that a user is using a wheelchair.

19. The user-adaptive variable-environment system according to claim 17, wherein
the user setting information specifies accessible floors for a user.
